(19) United States
(12) Patent Application Publication
(10) Pub. No.: US 2024/0281541 A1
(43) Pub. Date: Aug. 22, 2024

(54) FUNCTION ALLOCATION CONTROL APPARATUS, FUNCTION ALLOCATION CONTROL METHOD AND PROGRAM

(71) Applicant: NIPPON TELEGRAPH AND TELEPHONE CORPORATION, Tokyo (JP)

(72) Inventor: Yuta KAZATO, Tokyo (JP)

(73) Assignee: NIPPON TELEGRAPH AND TELEPHONE CORPORATION, Tokyo (JP)

(21) Appl. No.: 18/570,545

(22) PCT Filed: Jun. 18, 2021
(86) PCT No.: PCT/JP2021/023228

§ 371 Date: Dec. 14, 2023

(51) Int. Cl. G06F 21/57; G06F 21/54

(52) U.S. Cl. CPC G06F 21/577; G06F 21/54

(57) ABSTRACT

A function allocation control device for controlling a security verification system that executes a security verification function allocated to a target entity, the function allocation control device including: a trust score calculation unit configured to calculate a trust score indicating a security level of each entity on the basis of verification result information indicating a result of verifying security of each entity; a security verification function allocation unit configured to allocate a security verification function to each entity on the basis of the calculated trust score and resource information indicating a resource used for achieving the security verification function allocated to each entity; and a security verification function control unit configured to control the security verification system so as to execute the allocated security verification function.

### TECHNICAL FIELD

The present invention relates to a function allocation control device, a function allocation control method, and a program.

### BACKGROUND ART

In recent years, changes in threats and attack methods related to cyber-attacks, the promotion of cloud computing, the diversification of business operations due to the spread of remote work, and the like, have pointed out the limitations of the traditional perimeter security model. For this reason, a zero-trust network has been proposed as a new security model in the network. The basic principle of the security model is “not to trust anything,” and the security model is configured to perform continuous security verification on an apparatus connected to the network or a user operating the device, provides minimum access rights, and performs dynamic access control to information assets.

For example, NPL 1 discloses an apparatus for detecting a behavior (botnet detection) as an example of security verification. The apparatus performs threshold checking based on a plurality of determination criteria corresponding to a traffic type on the basis of various logs, and determines that there is a possibility that a terminal that has performed communication exceeding the criteria has been infected with a bot.

In addition, NPL 2 discloses a technique for setting an access level for each role of a user in a company and for executing security verification from a behavior such as authentication of the user and an IP address of an access source. In the technique, when a suspicious behavior is detected, the trust score is subtracted from an upper limit value 100 and calculated, and when the trust score is equal to or lower than an access level, dynamic access control is performed based on the trust score of a subtraction system that does not permit access.

In addition, NPL 3 discloses a method of managing trust information using a hierarchical blockchain for maintaining trust information between IoT systems.

### CITATION LIST

### Non Patent Literature

[NPL 1] “Palo Alto Networks Products Behavior Detection (Botnet Detection),” Hitachi Solutions, [online], Internet <URL: https://www.hitachi-solutions.co.jp/paloalto/sp/products/ngfw/pa/function/botnet.html>
[NPL 2] Kawai, “Prototyping of zero trust network assuming in-house system and examination of security policy,” IEICE NS Study Group: NS2020-111, 2020
[NPL 3] S. Mayra, “Zero-trust hierarchical management in IoT.” IEEE international congress on Internet of Things (ICIOT), 2018.

### SUMMARY OF INVENTION

### Technical Problem

However, the problem with the conventional art is that when the zero-trust networking techniques are applied to a large network environment, there may be insufficient computing, communication, and other resources to perform security verification for a large number of entities. Insufficient resources may result in inadequate security verification, which may reduce the accuracy of security verification and the accuracy of trust scores based on it, resulting in false positives and the like.

An object of the disclosed technique is to reduce resources for implementing security verification.

### Solution to Problem

The disclosed technique is a function allocation control device for controlling a security verification system that executes a security verification function allocated to a target entity, the function allocation control device including: a trust score calculation unit configured to calculate a trust score indicating a security level of each entity on the basis of verification result information indicating a result of verifying security of each entity; a security verification function allocation unit configured to allocate a security verification function to each entity on the basis of the calculated trust score and resource information indicating a resource used for achieving the security verification function allocated to each entity; and a security verification function control unit configured to control the security verification system so as to execute the allocated security verification function.

### Advantageous Effects of Invention

Resources for implementing security verification can be reduced.

### BRIEF DESCRIPTION OF DRAWINGS

FIG. 1 is a diagram showing an example of a system configuration of a security verification system.

FIG. 2 is a diagram showing an example of verification result information.

FIG. 3 is a diagram showing an example of trust score information.

FIG. 4 is a diagram showing an example of first resource information.

FIG. 5 is a diagram showing an example of second resource information.

FIG. 6 is a flowchart showing an example of a flow of security verification control processing.

FIG. 7 is a diagram showing an example of a hardware configuration of a computer.

### DESCRIPTION OF EMBODIMENTS

An embodiment (present embodiment) of the present invention will be described below with reference to the drawings. The embodiment to be described below is merely exemplary, and the embodiment to which the present invention is applied is not limited to the following embodiment.

### Overview of Present Embodiment

A security verification system according to the present embodiment collects verification result information indicating a verification result of each entity and resource information related to each entity, and calculates a trust score on the basis of the verification result information. Then, the security verification system allocates a security verification function to each entity on the basis of the trust score and the resource information, and achieves the allocated security verification function.

The entity is a target entity on which security verification is performed and is mainly a user and an apparatus. When the entity is a user, security verification to the user is performed by, for example, knowledge authentication (password authentication, location authentication, etc.), authentication of an owner, biometric authentication, or the like. In the user authentication, multi-element authentication obtained by combining a plurality of these authentications is widely used, wherein a trust score of the user is calculated from a security verification result of each authentication, and the propriety of access to an access request from an apparatus operated by the user to an information asset is determined and controlled on the basis of the calculated trust score.

Next, when the entity is an apparatus, security verification for the apparatus is performed by, for example, integrity verification by a static verification method such as binary analysis or firmware analysis, or a dynamic verification method such as communication verification by network scan or software behavior verification by vulnerability scan. Security verification for the apparatus is realized by combining the static verification method and the dynamic verification method.

### (Example of System Configuration of Security Verification System)

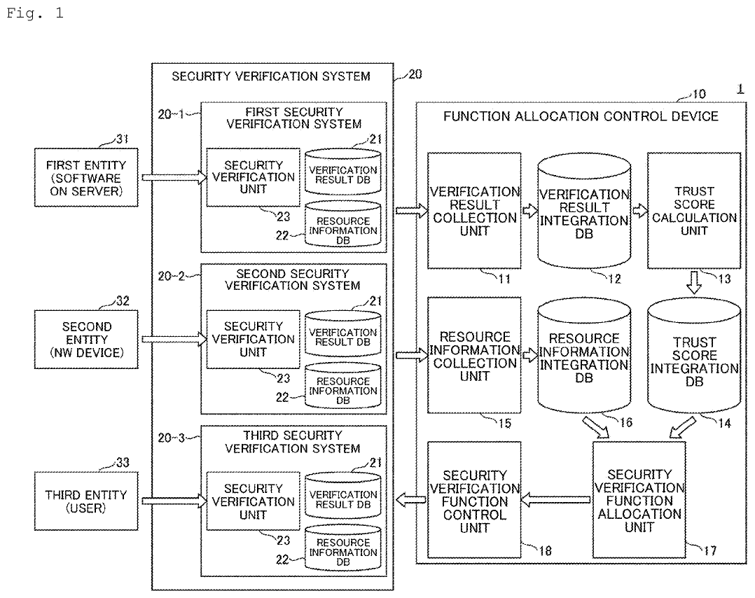

FIG. 1 is a diagram showing an example of a system configuration of a security verification system. A security verification system 1 includes a function allocation control device 10 and a security verification system 20.

The function allocation control device 10 is communicably connected to the security verification system 20. The function allocation control device 10 collects verification result information indicating a verification result of each entity and resource information related to each entity from the security verification system 20, and calculates a trust score on the basis of the verification result information. Then, the function allocation control device 10 allocates a security verification function to each entity on the basis of the trust score and the resource information, and controls the security verification system 20.

The security verification system 20 includes a plurality of security verification systems (for example, a first security verification system 20-1, a second security verification system 20-2, a third security verification system 20-3 and the like). The security verification system 20 acquires various types of information about each entity via a communication network or the like, and achieves the security verification function about each entity.

Each security verification system includes a verification result DB 21, a resource information DB 22, and a security verification unit 23.

The verification result DB 21 is a database for storing verification result information indicating a result of verifying the security of each entity by each security verification system. A specific example of the verification result information will be described below.

The resource information DB 22 is a database for storing resource information including a list of verification functions provided in each security verification system, resources consumed by each verification function, history of resources used by the verification function allocated to each entity, and the like. A specific example of the resource information will be described below.

The security verification unit 23 executes security verification allocated to each entity according to a determined verification schedule. For example, the security verification unit 23 included in the first security verification system 20-1 executes security verification of a first entity 31. When the first entity 31 is software on a server, the security verification unit 23 included in the first security verification system 20-1 accesses a server device to execute security verification on target software.

Also, the security verification unit 23 included in the second security verification system 20-2 executes security verification of a second entity 32. When the second entity 32 is a network apparatus, the security verification unit 23 included in the second security verification system 20-2 accesses the network apparatus and executes security verification on a target network apparatus.

The security verification unit 23 included in the third security verification system 20-3 executes security verification of a third entity 33. When the third entity 33 is a user, the security verification unit 23 included in the third security verification system 20-3 accesses a terminal operated by the user, and executes security verification about the user via a target terminal.

Although FIG. 1 shows an example in which each entity and each security verification system are related one-on-one, each security verification system may correspond to a plurality of entities.

### (Example of Functional Configuration of Function Allocation Control Device)

Next, an example of a functional configuration of the function allocation control device 10 will be described. The function allocation control device 10 includes a verification result collection unit 11, a verification result integration DB 12, a trust score calculation unit 13, a trust score integration DB 14, a resource information collection unit 15, a resource information integration DB 16, a security verification function allocation unit 17, and a security verification function control unit 18.

The verification result collection unit 11 collects verification result information from the security verification system 20. The verification result integration DB 12 is a database for storing the collected verification result information.

The trust score calculation unit 13 calculates a trust score of each entity on the basis of the verification result information of each entity stored in the verification result integration DB 12. The trust score is a value indicating the security level of each entity, and is expressed by a numerical value or a trust level based on the numerical value. For example, the trust score may be a numerical value from 0 to 1, or may be a tiered classification such as high trust, medium trust, and low trust.

The trust score integration DB 14 is a database for storing information indicating the calculated trust score of each entity.

The resource information collection unit 15 collects resource information from the security verification system 20. The resource information integration DB 16 is a database for storing the collected resource information.

The security verification function allocation unit 17 extracts an entity to be a candidate for changing the number of security verification functions to be allocated or changing the verification schedule, on the basis of information indicating the trust score of each entity stored in the trust score integration DB 14. Then, for the extracted entity, the security verification function allocation unit 17 determines whether or not to change the allocation of the security verification function or whether or not to change the verification schedule, on the basis of the resource information stored in the resource information integration DB 16. If the change is to be made, the security verification function allocation unit 17 determines the more specific content of the change.

For example, the security verification function allocation unit 17 extracts an entity showing high trust as a candidate for changing the verification schedule so as to reduce the number of security verification functions to be allocated or to reduce the verification execution frequency. For example, a threshold Th_{TRUST} indicating high trust is set in advance, and the security verification function allocation unit 17 extracts an entity whose trust level S satisfies ≥Th_{TRUST} during a reference period t, as the candidate for changing the verification schedule so as to reduces the number of security verification functions to be allocated to reduce the verification frequency.

Then, for the extracted entity, the security verification function allocation unit 17 determines whether or not to cancel the allocation of an allocated security verification function or whether or not to reduce the verification frequency, on the basis of the resource information stored in the resource information integration DB 16. When canceling the allocation or reducing the verification frequency, the security verification function allocation unit 17 determines a security verification function to be further canceled or determines the interval of executing verification after the change. For example, when determining based on the resource information that there is not enough room in the current resources, the security verification function allocation unit 17 cancels the allocation of the allocated security verification function or reduce the verification frequency.

In so doing, the security verification function allocation unit 17 may determine whether or not to cancel the allocation of the allocated security verification function or whether or not to increase the verification execution interval, on the basis of the verification result information or other information, so that not only the resource amount but also the security level are not reduced or risks are not expanded.

The security verification function allocation unit 17 extracts an entity showing low trust as a candidate for increasing the number of security verification functions to be allocated. For example, a threshold Th_{UNTRUST} indicating low trust is set in advance, and the security verification function allocation unit 17 extracts an entity whose trust level S satisfies S<Th_{UNTRUST}, as the candidate for increasing the number of security verification functions to be allocated.

Then, for the extracted entity, the security verification function allocation unit 17 determines whether or not to increase the number of security verification functions to be allocated, on the basis of the resource information stored in the resource information integration DB 16. When increasing the number of security verification functions to be allocated, the security verification function allocation unit 17 determines a security verification function to be further added. For example, when determining based on the resource information that there is enough room in the current resources even after adding a verification function, the security verification function allocation unit 17 increases the number of security verification functions to be allocated.

The security verification function control unit 18 controls the security verification system 20 on the basis of the determined change in allocation of security verification functions or the change in verification frequency.

### (Specific Example of Information Handled in Security Verification System)

A specific example of information handled in the security verification system 1 will be described next.

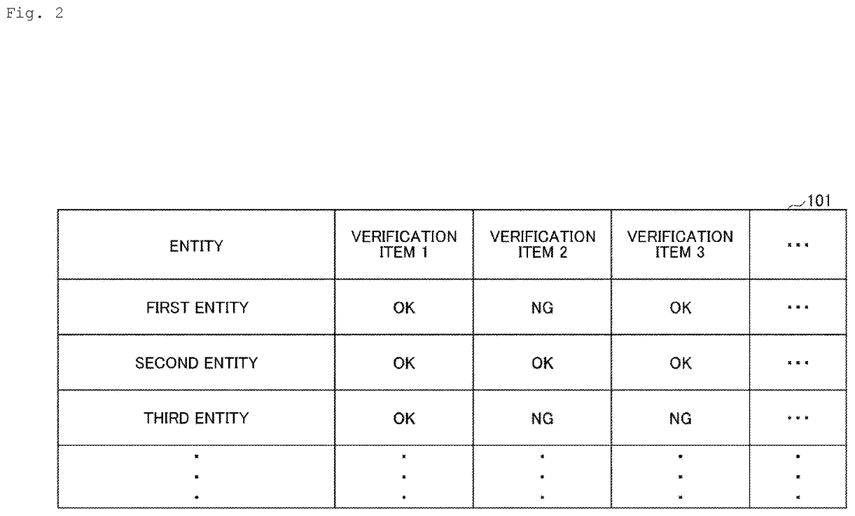

FIG. 2 is a diagram showing an example of verification result information. Verification result information 101 is an example of information collected by the verification result collection unit 11 and stored in the verification result integration DB 12. The verification result information 101 includes a verification result (OK or NG) of each verification item for each entity. It should be noted that the verification result does not have to be a binary value of OK and NG, but can be, for example, a numerical value indicating the level of security.

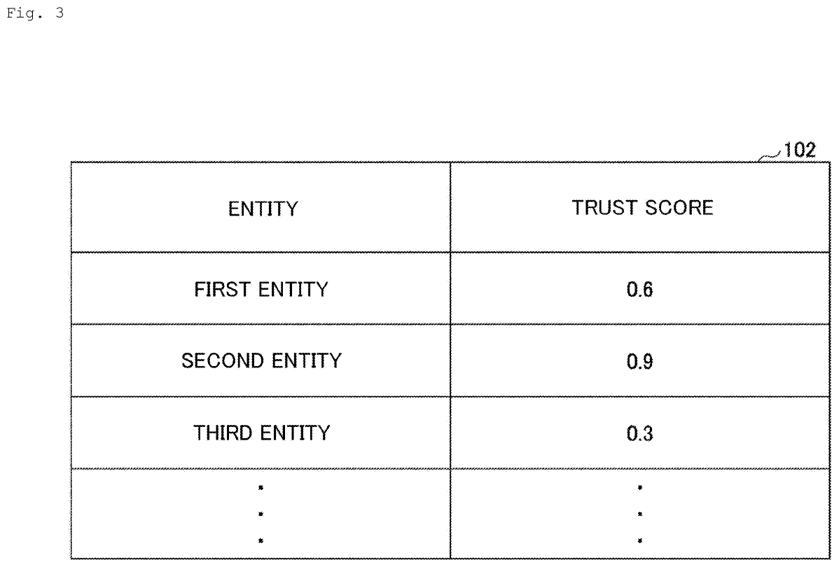

FIG. 3 is a diagram showing an example of trust score information. Trust score information 102 is an example of information indicating a trust score calculated by the trust score calculation unit 13 and stored in the trust score integration DB 14. The trust score information 102 includes a trust score of each entity. For example, the trust score is a numerical value from 0 to 1, and the larger the value is, the higher the trust is. However, the trust score may take other forms, such as tiered values indicating high, medium, and low.

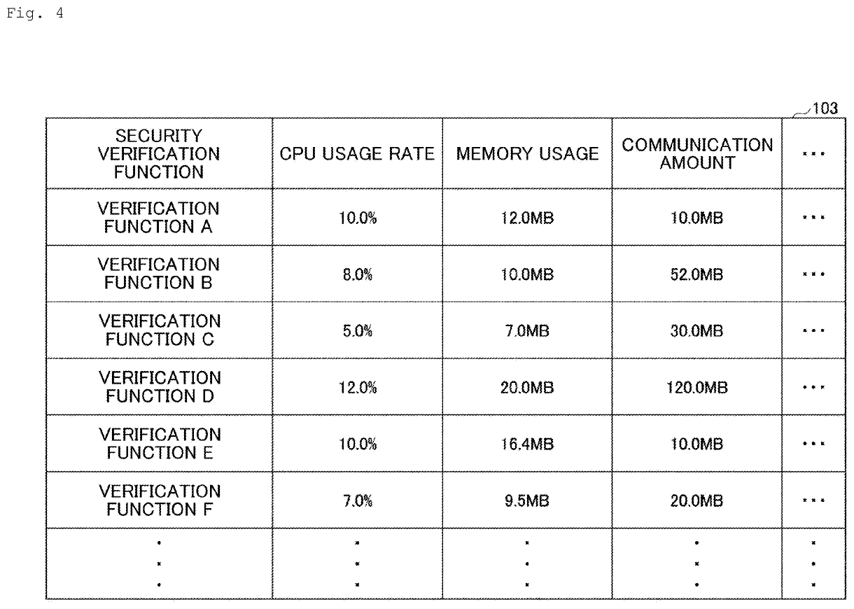

FIG. 4 is a diagram showing an example of first resource information. First resource information 103 is a part of resource information collected by the resource information collection unit 15 and stored in the resource information integration DB 16.

The first resource information 103 is information indicating a resource to be used in each verification function of the security verification system 20 for each verification function. Examples of the types of resources include calculation resources (CPU usage rate, memory usage, etc.) and communication resources (communication amount, etc.).

The first resource information 103 is information indicating a standard resource to be used in each security verification function, and the resource to be actually used is increased/decreased according to the communication environment, an execution state of other processing, and the like.

The security verification function allocation unit 17 can determine, on the basis of the first resource information 103, an increase amount of resources when, for example, a security verification function is added.

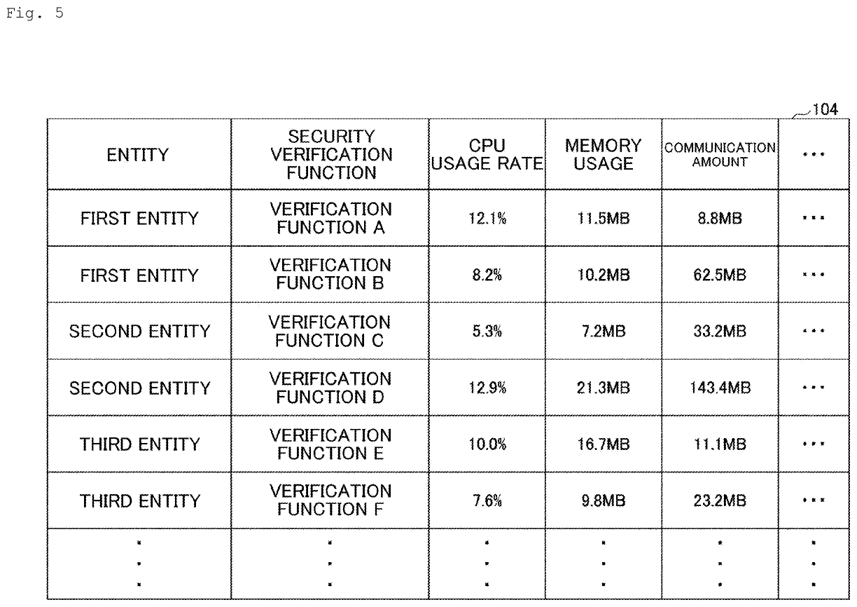

FIG. 5 is a diagram showing an example of second resource information. Second resource information 104 is a part of resource information collected by the resource information collection unit 15 together with the first resource information 103 and stored in the resource information integration DB 16.

The second resource information 104 is information indicating a resource actually used for the security verification function by each entity. The types of resources are the same as those of the first resource information 103.

The security verification function allocation unit 17 can determine, on the basis of the second resource information 104, a reduction amount of resources when, for example, reducing the security verification functions or reducing the verification frequency.

### (Example of Operation of Function Allocation Control Device)

Next, an example of the operation of the function allocation control device 10 will be described with reference to the drawings. The function allocation control device 10 periodically starts security verification control processing in batch processing or the like once a day, for example.

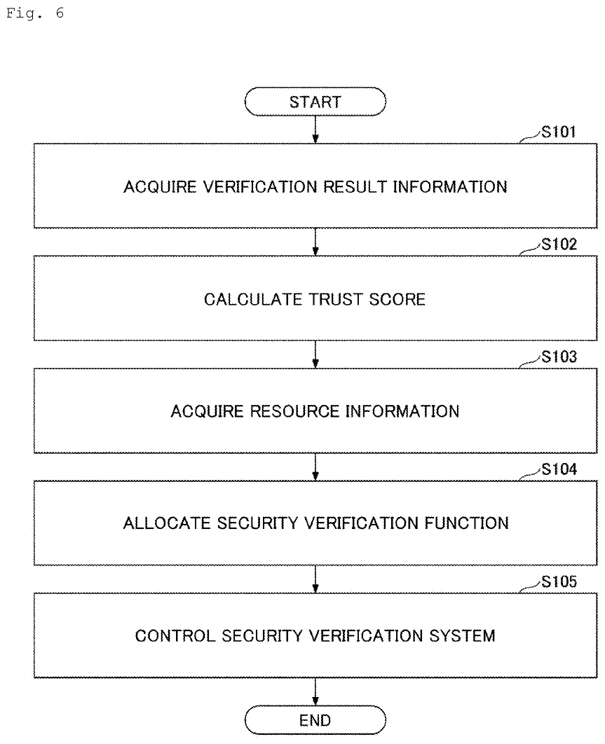

FIG. 6 is a flowchart showing an example of the flow of the security verification control processing. The verification result collection unit 11 acquires verification result information by collecting it from the security verification system 20 (step S101). The trust score calculation unit 13 calculates a trust score on the basis of the verification result information (step S102).

Next, the resource information collection unit 15 collects the resource information from the security verification system 20 to acquire the resource information (step S103). The function allocation control device 10 may execute steps S103 and S101 in reverse order or may execute these steps in parallel.

Next, the security verification function allocation unit 17 allocates security verification functions on the basis of the trust score information and the resource information (step S104). For example, it is assumed that the threshold Th_{TRUST} is set to 0.7, that the threshold Th_{UNTRUST} is set to 0.4, and that the trust level S of each entity is the value shown in FIG. 3.

In this case, the security verification function allocation unit 17 extracts a second entity, which is an entity whose trust level S satisfies S≥Th_{TRUST}, as the candidate for changing the verification schedule so as to reduce the number of security verification functions to be allocated or to reduce the verification execution frequency.

Then, the security verification function allocation unit 17 determines, based on the second resource information 104, whether or not to reduce the security verification functions or to reduce the verification execution frequency, from the information on resources used for security verification of the current second entity, and further determines a security verification function to be canceled or determines an interval of execution of verification after the change.

The security verification function allocation unit 17 also extracts the third entity, which is an entity whose trust level S satisfies S<Th_{UNTRUST}, as the candidate for increasing the number of security verification functions to be allocated.

Then, based on the second resource information 104, the security verification function allocation unit 17 determines information on resources used for security verification of the current second entity, and determines information on resources obtained when a security verification function is added. Then, the security verification function allocation unit 17 determines whether or not to increase the number of security verification functions to be allocated, and when increasing the number of security verification functions to be allocated, determines a security verification function to be further added.

Then, the security verification function control unit 18 controls the security verification system 20 on the basis of the allocated security verification function (step S105).

### (Example of Hardware Configuration According to Present Embodiment)

The function allocation control device 10 can be implemented by, for example, causing a computer to execute a program describing the processing details described in the present embodiment. Note that the “computer” may be a physical machine or a virtual machine in the cloud. When using a virtual machine, the “hardware” described here is virtual hardware.

The program can be recorded on a computer-readable recording medium (portable memory, and the like), stored, and distributed. It is also possible to provide the program through a network such as the Internet or an email.

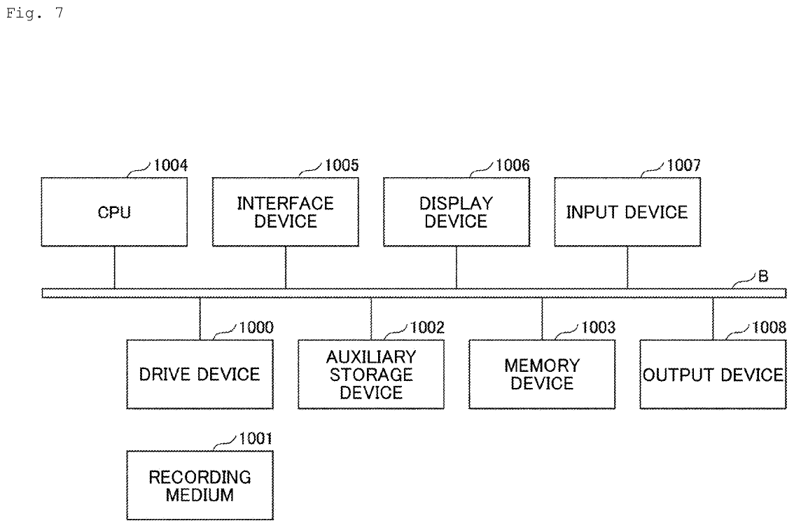

FIG. 7 is a diagram showing an example of a hardware configuration of the computer. The computer shown in FIG. 7 has a drive device 1000, an auxiliary storage device 1002, a memory device 1003, a CPU 1004, an interface device 1005, a display device 1006, an input device 1007, an output device 1008, and the like which are connected to each other via a bus B, respectively.

A program for realizing processing by the computer is provided by, for example, a recording medium 1001 such as a CD-ROM or a memory card. When the recording medium 1001 in which a program is stored is set in the drive device 1000, the program is installed from the recording medium 1001 to the auxiliary storage device 1002 via the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads the program from the auxiliary storage device 1002 and stores it when a program activation instruction is received. The CPU 1004 implements functions relating to the device in accordance with programs stored in the memory device 1003. The interface device 1005 is used as an interface for connecting to a network. The display device 1006 displays a GUI (Graphical User Interface) or the like by a program. The input device 1007 is composed of a keyboard, a mouse, buttons, a touch panel, or the like and is used for inputting various operational instructions. The output device 1008 outputs a calculation result. Note that the computer may include a GPU (Graphics Processing Unit) or a TPU (Tensor Processing Unit) instead of the CPU 1004 or may include the GPU or TPU in addition to the CPU 1004. In such a case, a configuration is possible in which processing is divided and executed, such as the GPU or TPU executing processing which requires special computation and the CPU 1004 executes other processing.

### Effect of Present Embodiment

According to the function allocation control device 10 of the present embodiment, verification result information indicating a verification result of each entity and resource information related to each entity are collected, and a trust score is calculated on the basis of the verification result information. Then, the security verification system allocates a security verification function to each entity on the basis of the trust score and the resource information, and achieves the allocated security verification function. This can reduce resources for executing security verification while minimizing the deterioration of security.

### Conclusion of Embodiment

The present specification describes at least a function allocation control device, a function allocation control method, and a program described in the following clauses.

### (Clause 1)

A function allocation control device for controlling a security verification system that executes a security verification function allocated to a target entity, the function allocation control device comprising:
a trust score calculation unit configured to calculate a trust score indicating a security level of each entity on the basis of verification result information indicating a result of verifying security of each entity;
a security verification function allocation unit configured to allocate a security verification function to each entity on the basis of the calculated trust score and resource information indicating a resource used for achieving the security verification function allocated to each entity; and
a security verification function control unit configured to control the security verification system so as to execute the allocated security verification function.

### (Clause 2)

The function allocation control device according to clause 1, wherein the security verification function allocation unit extracts an entity that is a candidate for changing the number of security verification functions to be allocated or changing a verification schedule, on the basis of the calculated trust score, determines whether or not to change allocation of the security verification function or whether or not to change the verification schedule, for the extracted entity on the basis of the resource information, and, when making a change, determines a more specific content of the change.

### (Clause 3)

The function allocation control device according to clause 2, wherein the security verification function allocation unit extracts an entity indicating high trust as a candidate for changing the verification schedule so as to reduce the number of security verification functions to be allocated or reduce a verification execution frequency.

### (Clause 4)

The function allocation control device according to clause 3, wherein the resource information includes information indicating a resource actually used by each entity in the security verification function, and
the security verification function allocation unit determines, on the basis of the resource information, a reduction amount of resources when reducing the security verification functions or reducing a verification frequency.

### (Clause 5)

The function allocation control device according to any one of clauses 2 to 4, wherein the security verification function allocation unit extracts an entity indicating low trust as a candidate for increasing the number of security verification functions to be allocated.

### (Clause 6)

The function allocation control device according to clause 5, wherein the resource information includes information indicating a standard resource used in each security verification function, and
the security verification function allocation unit determines, on the basis of the resource information, an increase amount of resources when a security verification function is added.

### (Clause 7)

A function allocation control method executed by a device for controlling a security verification system that executes a security verification function allocated to a target entity, the function allocation control method comprising the steps of:
calculating a trust score indicating a security level of each entity on the basis of verification result information indicating a result of verifying security of each entity; allocating a security verification function to each entity on the basis of the calculated trust score and resource information indicating a resource used for achieving the security verification function allocated to each entity; and controlling the security verification system so as to execute the allocated security verification function.

### (Clause 8)

A program for causing a computer to function as each unit of the function allocation control device according to any one of clauses 1 to 6.

Although the embodiment has been described above, the present invention is not limited to such a specific embodiment, and various modifications and changes can be made within the scope of the gist of the present invention described in the claims.

### REFERENCE SIGNS LIST

1 Security verification system
10 Function allocation control device
11 Verification result collection unit
12 Verification result integration DB
13 Trust score calculation unit
14 Trust score integration DB
15 Resource information collection unit
16 Resource information integration DB
17 Security verification function allocation unit
18 Security verification function control unit
20 Security verification system
21 Verification result DB
23 Resource information DB
23 Security verification unit
101 Verification result information
102 Trust score information
103 First resource information
104 Second resource information
1000 Drive device
1001 Recording medium
1002 Auxiliary storage device
1003 Memory device
1004 CPU
1005 Interface device
1006 Display device
1007 Input device
1008 Output device

1. A function allocation control device for controlling a security verification system that executes a security verification function, the function allocation control device comprising a processor configured to execute operations comprising:
calculating a trust score, the trust score indicating a security level of each entity on the basis of verification result information, and the verification result information indicating a result of verifying security of each entity;
allocating a security verification function to each entity on the basis of the calculated trust score and resource information, the resource information indicating a resource used for achieving the security verification function allocated to each entity; and
transmitting information of the allocated security verification function to the security verification system configured to execute the allocated security verification function.

2. The function allocation control device according to claim 1, wherein the allocating further comprises:
extracting an entity that is a candidate for changing the number of security verification functions to be allocated or changing a verification schedule, on the basis of the calculated trust score,
determining whether or not to change allocation of the security verification function or whether or not to change the verification schedule, for the extracted entity on the basis of the resource information, and,
determining, based on the determining to change, a more specific content of the change.

3. The function allocation control device according to claim 2, wherein the allocating further comprises extracting an entity indicating high trust as a candidate for changing the verification schedule either to reduce the number of security verification functions to be allocated or to reduce a verification execution frequency.

4. The function allocation control device according to claim 3, wherein the resource information includes information indicating a resource actually used by each entity in the security verification function, and
the allocating further comprises determining, on the basis of the resource information, a reduction amount of resources to reduce the security verification functions or to reduce a verification frequency.

5. The function allocation control device according to claim 2, wherein the allocating further comprises extracting an entity indicating low trust as a candidate for increasing the number of security verification functions to be allocated.

6. The function allocation control device according to claim 5, wherein the resource information includes information indicating a standard resource used in each security verification function, and
the allocating further comprises determining, on the basis of the resource information, an increase amount of resources when a security verification function is added.

7. A computer-implemented method for controlling a security verification system that executes a security verification function, comprising:
calculating a trust score, the trust score indicating a security level of each entity on the basis of verification result information, and the verification result information indicating a result of verifying security of each entity;
allocating a security verification function to each entity on the basis of the calculated trust score and resource information, the resource information indicating a resource used for achieving the security verification function allocated to each entity; and
transmitting information of the allocated security verification function to the security verification system configured to execute the allocated security verification function.

8. A computer-readable non-transitory recording medium storing a computer-executable program instructions that when executed by a processor cause a computer system to execute operations for controlling a security verification system that executes a security verification function, comprising:
calculating a trust score, the trust score indicating a security level of each entity on the basis of verification result information, and the verification result information indicating a result of verifying security of each entity;
allocating a security verification function to each entity on the basis of the calculated trust score and resource information, the resource information indicating a resource used for achieving the security verification function allocated to each entity; and
transmitting information of the allocated security verification function to the security verification system configured to execute the allocated security verification function.

9. The function allocation control device according to claim 3, wherein the allocating further comprises extracting an entity indicating low trust as a candidate for increasing the number of security verification functions to be allocated.

10. The computer-implemented method according to claim 7, wherein the allocating further comprises:
extracting an entity that is a candidate for changing the number of security verification functions to be allocated or changing a verification schedule, on the basis of the calculated trust score,
determining whether or not to change allocation of the security verification function or whether or not to change the verification schedule, for the extracted entity on the basis of the resource information, and,
determining, based on the determining to change, a more specific content of the change.

11. The computer-implemented method according to claim 10, wherein the allocating further comprises extracting an entity indicating high trust as a candidate for changing the verification schedule either to reduce the number of security verification functions to be allocated or to reduce a verification execution frequency.

12. The computer-implemented method according to claim 11, wherein the resource information includes information indicating a resource actually used by each entity in the security verification function, and
the allocating further comprises determining, on the basis of the resource information, a reduction amount of resources to reduce the security verification functions or to reduce a verification frequency.

13. The computer-implemented method according to claim 10, wherein the allocating further comprises extracting an entity indicating low trust as a candidate for increasing the number of security verification functions to be allocated.

14. The computer-implemented method according to claim 13, wherein the resource information includes information indicating a standard resource used in each security verification function, and
the allocating further comprises determining, on the basis of the resource information, an increase amount of resources when a security verification function is added.

15. The computer-implemented method according to claim 11, wherein the allocating further comprises extracting an entity indicating low trust as a candidate for increasing the number of security verification functions to be allocated.

16. The computer-readable non-transitory recording medium according to claim 8, wherein the allocating further comprises:
extracting an entity that is a candidate for changing the number of security verification functions to be allocated or changing a verification schedule, on the basis of the calculated trust score,
determining whether or not to change allocation of the security verification function or whether or not to change the verification schedule, for the extracted entity on the basis of the resource information, and,
determining, based on the determining to change, a more specific content of the change.

17. The computer-readable non-transitory recording medium according to claim 16, wherein the allocating further comprises extracting an entity indicating high trust as a candidate for changing the verification schedule either to reduce the number of security verification functions to be allocated or to reduce a verification execution frequency.

18. The computer-readable non-transitory recording medium according to claim 17, wherein the resource information includes information indicating a resource actually used by each entity in the security verification function, and
the allocating further comprises determining, on the basis of the resource information, a reduction amount of resources to reduce the security verification functions or to reduce a verification frequency.

19. The computer-readable non-transitory recording medium according to claim 16, wherein the allocating further comprises extracting an entity indicating low trust as a candidate for increasing the number of security verification functions to be allocated.

20. The computer-readable non-transitory recording medium according to claim 19, wherein the resource information includes information indicating a standard resource used in each security verification function, and
the allocating further comprises determining, on the basis of the resource information, an increase amount of resources when a security verification function is added.
